(19) United States
(12) Patent Application Publication
(10) Pub. No.: US 2006/0070405 A1
(43) Pub. Date: Apr. 6, 2006

(54) Method for the production of amber glass with reduced sulfur-containing emissions

(75) Inventors: Susan Jones, Valley Park, MO (US); Charles E. Brossia, Chesterfield, MO (US)

Correspondence Address: STORM L.L.P., BANK OF AMERICA PLAZA, 901 MAIN STREET, SUITE 7100, DALLAS, TX, 75202, US

(73) Assignee: Anheuser-Busch, Inc.

(21) Appl. No.: 10/959,690

(22) Filed: Oct. 6, 2004

(51) Int. Cl. C03B 5/173

(52) U.S. Cl. 65/29.18; 65/134.3

(57) ABSTRACT

A method is disclosed for the production of amber glass with reduced sulfur-containing emissions comprising measuring the amber intensity of glass exiting a furnace and adjusting the amount of iron being added to the furnace in response to measuring the amber intensity.

### FIELD OF THE INVENTION

The present invention relates generally to methods of making glass. More particularly, the present invention relates to an improved method of making amber glass.

### BACKGROUND

The art of making glass has been practiced for centuries. Glass continues today to be an important material for many applications, including windows, medical and scientific equipment, and food services dishes and containers. One type of glass known as “amber glass” is particularly desirable in certain applications including container glass for beverages.

Amber glass is named for its distinctive amber color, which comes from interactions of sulfur and iron atoms in the glass. One consequence of using sulfur as an ingredient in amber glass is that sulfur-containing emissions are released during the glassmaking process. Sulfur-containing gases can be environmentally hazardous, and their release into the atmosphere is strictly limited by environmental regulations. Many manufacturers of amber glass have been unable to keep emissions within permitted levels while making sufficient quantities of glass to meet customers' needs. One common method of keeping sulfur emissions low without sacrificing glass production is to install scrubbers to treat the produced gases and remove sulfur before releasing the gases to the environment. However, scrubbers are expensive to install and operate.

Therefore, what is needed is a method and composition of amber glass production with reduced sulfur emissions.

### SUMMARY

It is a general object of the present invention to provide a method for the production of amber glass with reduced sulfur emissions. This and other objects of the present invention are achieved by providing

A method for the production of amber glass with reduced sulfur-containing emissions comprising measuring the amber intensity of glass exiting a furnace and adjusting the amount of iron being added to the furnace in response to measuring the amber intensity.

According to one preferred embodiment of the present invention, the iron is at least 50% ferric iron.

According to another preferred embodiment, the iron is in the form of Fe₂O₃.

According to another preferred embodiment the method comprises the additional step of adding raw materials to the furnace, wherein the iron is part of the raw materials and wherein the raw materials contain less than 0.1 wt % iron pyrite.

According to another preferred embodiment the method comprises the additional step of adding raw materials to the furnace, wherein the raw materials are substantially free of iron pyrite.

According to another preferred embodiment the raw materials contain less than 0.1 wt % carbon.

According to another preferred embodiment the raw materials contain less than 0.05 wt % salt cake.

According to another preferred embodiment the raw materials contain less than 4.0 lb Sulfur (expressed as SO₃ equivalent) per ton of glass.

According to another preferred embodiment the raw materials have an iron (expressed as Fe₂O₃ equivalent) to sulfur (expressed as SO₃ equivalent) weight ratio of at least 6.

### BRIEF DESCRIPTION OF THE DRAWINGS

FIG. 1 is a diagram of a glassmaking operation; and

FIG. 2 is a block diagram of a glass distributor and equipment for glass forming.

### DETAILED DESCRIPTION

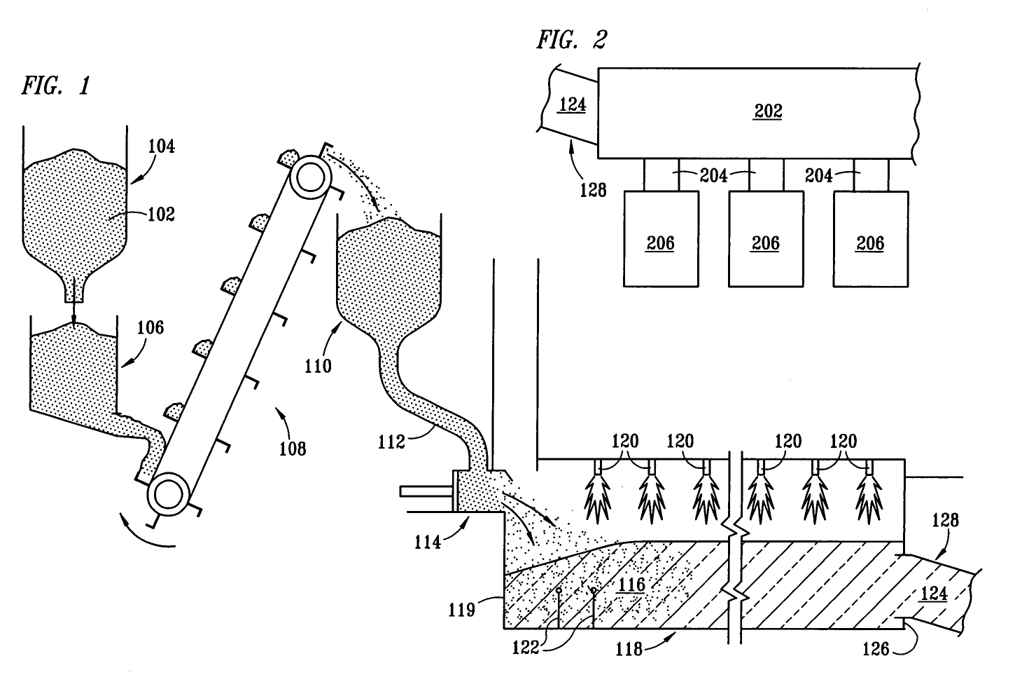

FIG. 1 shows a typical arrangement of equipment for making amber glass. Raw materials 102 are measured into a surge hopper 104. Raw materials 102 are preferably in a granulated state. From surge hopper 104, raw materials 102 are fed into a mixer 106, where the granules are mixed. After mixing, raw materials 102 are moved via a conveyer 108 to one or more storage silos 110. The mixed raw materials 102 are stored in silo 110 until needed for making glass. When it is time to add raw material 102 to a furnace 118, raw materials 102 are fed through a chute 112 from silo 110 to a batch charger 114. Batch charger 114 then pushes raw materials 102 onto a glass melt 116 in furnace 118. The glass melt 116 in the furnace 118 is left over from a previous batch of raw materials.

Furnace 118 is preferably a long, rectangular box with a length of about 75 ft, a width of about 25 ft, and a depth of about 5 ft. However, many other sizes and shapes of furnaces are known and may be used. The raw materials 102 enter the furnace 118 near a back wall 119 of the furnace 118.

Raw materials 102 and the glass melt 116 are heated in furnace 118 using natural gas burners 120 as well as electrical resistance heating. The electrical resistance heating is provided through electrodes 122, which extend into the glass melt 116. In addition to providing additional heat, the electrical resistance heating also promotes convection within the glass melt 116, which aids mixing of the glass melt 116 and raw materials 102. As raw materials 102 are heated, melted and mixed, chemical reactions occur which form the compounds that comprise the glass 124. A front wall 126 is at the opposite end of furnace 118 from the back wall 119. Glass 124 exits furnace 118 through an opening 128 in front wall 126 called the “throat.” As the level of raw materials 102 and glass melt 116 in furnace 118 drops, batch charger 114 pushes more raw materials 102 into furnace 118.

Referring to FIG. 2, after passing through the throat 128, glass 124 enters a distributor 202 and is distributed through one of a plurality of forehearths 204, which lead to shops 206, where the glass 124 is made into a finished product such as bottles.

Amber glass is glass with a distinctive amber color that is normally produced by sulfur interacting with iron in the glass. Raw materials for amber glass typically include sand (mainly silicon dioxide, SiO₂), soda ash (sodium carbonate, Na₂CO₃), limestone (calcium carbonate, CaCO₃), salt cake (sodium sulphate, Na₂SO₄), iron pyrite (FeS₂), alumina (Al₂O₃), iron (III) oxide (Fe₂O₃), and carbon. A typical source of alumina is aplite, which contains 22 wt % Al₂O₃Al2O3. A typical source of iron (III) oxide is melite, which contains 19 wt % Fe₂O₃. A typical source of carbon is anthracite, which contains greater than 75% carbon, with a small percentage of ash and trace amounts of other ingredients. Other raw materials and combinations are known in the art. A typical prior art batch formula for amber glass is shown in Table 1 below. The sources of sulfur in the typical batch formula shown in Table 1 are iron pyrite and salt cake. In many cases, crushed glass, known as cullet, is also mixed with the raw materials.

TABLE 1
(Prior Art Typical Batch Ingredients)

| Ingredient | Weight Percent |
|---|---|
| Sand | 56.9 |
| Soda Ash | 19.3 |
| Limestone | 16.6 |
| Salt Cake | 0.11 |
| Iron Pyrite | 0.22 |
| Aplite | 6.4 |
| Melite | 0.2 |
| Carbon | 0.15 |

The weights shown in Table 1 are on a pre-melting basis.

Described herein is a method and composition for making amber glass using raw materials containing less sulfur. This improved formula results in lower sulfur emissions while still providing a sufficient amber color and maintaining other characteristics of amber container glass. Aspects of the improved method and composition include reducing the overall mass of sulfur introduced into the furnace, shifting the overall valence state of the input sulfur to a more reduced state, minimizing the amount of carbon used in the reaction, and controlling the transmissivity of thin-walled glass containers using iron and carbon additives, as opposed to carbon only, which is the prior art. In the prior art, reducing the overall mass of sulfur introduced into the furnace, and using carbon alone to maintain a suitably intense amber color, resulted in unstable amber glass. Such glass readily forms bubbles that adversely affect the container quality and economics of container manufacture.

Overall Sulfur Reduction and Shifting of Sulfur Valence State

It has been discovered that reducing the sulfur content of the batch formula and shifting the overall valence state of the sulfur in the batch to a more reduced state favors sulfur retention in the glass melt and minimizes sulfur emissions, but can result in unstable glass color and can increase seed defects.

The primary sources of sulfur in typical amber glass formulas are salt cake and iron pyrite. In the preferred method and formula described herein, the total amount of sulfur is reduced in the batch by decreasing or eliminating the amount of salt cake used and preferably eliminating all iron pyrite. Blast furnace slag is used as a source of iron and sulfur. The sulfur in blast furnace slag is in a preferred valence state compared to that in iron pyrite.

In a preferred embodiment the amount of salt cake is decreased from 0.11 to 0.04 wt % and iron pyrite is removed completely from the batch formula. Blast furnace slag, as well as melite, are the primary iron and sulfur sources in the improved formula. The total sulfur input is reduced about 50% from about 6.6 lb SO₂ per ton glass to 3.3 lb SO₂ per ton glass. Sulfur emissions are reduced by about 2/3 from about 4.9 lb SO₂/ton glass to about 1.7 lb SO₂/ton glass. Retained sulfur in the glass decreased from 0.04 wt % S⁻² to 0.025 wt % S⁻². Nevertheless, the desired amber intensity and hue are maintained.

Additionally, some sulfate is naturally present in raw materials such as sand and limestone as a contaminate. Preferably, sources of sand, limestone and other nominally sulfur free raw materials should be chosen which contain the least possible amount of sulfate.

Decrease Salt Cake

The role of salt cake is to improve the melting and fining of the glass. “Fining” or refining refers to the process of removing gaseous inclusions from the glass melt. Salt cake improves fining via several mechanisms. First, salt cake melts at relatively low temperatures to form a surfactant-like insoluble liquid layer. This liquid layer aids the dissolution of solid particles and the expulsion of gas bubbles. In addition, interfacial tension differences between the insoluble decomposition products of salt cake and the glass melt create vigorous convective mixing. Finally, at even higher temperatures, the decomposition products of salt cake form gas bubbles that provide a homogenizing effect as they are expelled from the melt. As bubbles of SO₂ gas rise through the melt, they sweep smaller bubbles of SO₂ and other gases from the glass.

Good fining depends in part on having enough sulfate present. However, too much sulfate may lead to “sulfur reboil.” Sulfur reboil occurs when sulfate or other gas bubbles that are dissolved in the molten glass reemerge later in the process due to a shift in the equilibrium partial pressure of SO₂ in the combustion space above the melt. If this occurs in the forehearth 204 section of the plant, there may not be enough time for all the bubbles to escape from the melt and, instead, the bubbles may become trapped in the cooled glass, in the form of seeds or blisters. This can also happen if the glass is reheated, a condition referred to as “thermal reboil.” There is no fundamental way to determine how much salt cake is needed or, indeed, if it is critical to the process at all. Early papers encourage the use of excess sulfate stoichiometrically for good melting and fining (Manring, 1967) with no regard for the penalty of sulfur emissions. Typical amber glass formulas use between 0.1 and 0.2 wt % salt cake. The preferred amount of salt cake for use in the present formula is 0.04 wt %. However, the present invention has also been used without any salt cake and all glass quality parameters including intense amber were achieved.

An additional benefit of decreasing salt cake is decreasing the Na₂SO₄ precipitation that builds up on the inside of the furnace stack. The buildup associated with the prior art formula required frequent (e.g., monthly) cleaning to prevent the stack from plugging. Using the improved formula, the stack requires cleaning only rarely.

Replace Iron Pyrite

Amber glass manufacturers commonly use iron pyrite as the primary sulfur source. Iron pyrite, FeS₂, is believed to lose one sulfur atom at relatively low temperatures, which combines with oxygen and is released as SO₂ emissions without becoming part of the glass. Therefore, iron pyrite is effectively FeS as far as the glass chemistry is concerned, but with built-in sulfur emissions.

Blast furnace slag (“slag”) is a by-product of steel production. Slag is composed mostly of silicates, such as aluminum, calcium and magnesium silicates. Sulfur is present in slag mostly as calcium sulfide, CaS. There are also small amounts of sodium, iron, magnesium, manganese and other metal sulfides present. The preferred blast furnace slag for the present method is sold under the trade name Calumite™ by the Calumite Company of Boca Raton, Fla.

One benefit of using blast furnace slag rather than iron pyrite as a sulfur source is that most of the sulfur present in blast furnace slag is in the reduced (sulfide) state, which is in the desired valence state to participate in color formation. Sulfur in the oxidized (sulfate) state does not participate in color formation, has low solubility in glass and is easily lost as SO₂ emissions. Therefore, the total input sulfur should be at least 65 percent in the sulfide state.

Using blast furnace slag as a sulfur source also improves fining, increases the melting rate and furnace output at lower temperatures, lowers fuel usage, and reduces refractory wear. Slag forms eutectic mixtures in the melt, which means that melting occurs at lower temperatures than in batches without slag. Thus, it is sometimes called a “melt accelerator.” Slag contains magnesium which is involved in forming the eutectic mixture. Because it comes from blast furnaces, slag is already a glassy matrix and so is compatible with the other raw materials.

Decrease Carbon

The molecular structure causing the amber color in glass, called a “chromophore,” is believed to be a tetrahedral complex of iron, sulfur and oxygen in the presence of an alkali ion of either sodium or potassium to preserve charge neutrality. Both reduced and oxidized forms of sulfur and iron coexist in the glass melt, but only reduced sulfur, S⁻², and oxidized iron, Fe participate in chromophore formation. More specifically, it is believed that only about 4% of the total reduced sulfur and 2% of the total oxidized iron are involved in producing amber color.

There is an operating window of sulfur and iron concentration and redox conditions that must be met for intense amber color. If the melt becomes over-reduced, amber color is lost since there is not enough oxidized iron, Fe⁺³. Conversely, color will be lost (light transmission will increase) when the melt is over-oxidized since there will no longer be enough sulfur in the reduced sulfide form. There is an optimum within this range that results in the most intense amber color.

The redox number of a glass batch is a measure of the ratio of reducing constituents to oxidizing constituents. Each glass ingredient is assigned a particular redox value which may be found in the literature for that material. The redox number of the batch is then determined by multiplying the redox number of each constituent by the weight of the constituent that is put into the batch and then summing the products. The target batch redox number for amber glass, regardless of the sulfur source, is preferably between −29 and −38 and is more preferably between −30 and −35.

Amber container glass is used to protect light sensitive products, such as beer, from wavelengths of light that are particularly deleterious. In addition, consumers have come to expect some products to be packaged in amber containers.

To block deleterious light, a glass container must have walls thick enough and with sufficient amber intensity such that light transmitted through the glass container wall to the container contents is minimized. The amber container glass must have low transmissivity at those wavelengths which are deleterious to the product. Overall transmissivity of a container wall is a function of both the intensity of the amber and the thickness of the glass at any given point. It is economically important that glass containers have thin walls and, consequently, the intensity or concentration of the amber chromophore must be correspondingly greater as the container wall becomes thinner.

The typical measure for glass container wall transmissivity is the percent transmission measured using a spectrophotometer at 550 nm and at 650 nm wavelengths with percent transmission at 550 nm preferably being in the range of 20 to 35% for a typical thin-walled glass beer container and the transmission at 650 nm preferably being about 1.5 times the percent transmission measured at 550 nm.

In amber glass, the redox ratio (also called the redox number) affects the amber intensity of the glass. It is known to control the redox ratio in a glass melt by adding to or removing from the batch small amounts of carbon, a strong reducing agent. Typical control using carbon involves adding or removing about 0.1 to 0.5 lbs of carbon per 9000 lb batch. However, there is a limit to the use of carbon to control color, especially when sulfur input is low. Excessive carbon increases the susceptibility of the glass to form SO₂ seeds and blisters and can reduce the amount of Fe+3 available to form the amber chromophore.

Therefore, it has been discovered that it is preferable to make small controlling adjustments to the redox ratio (and therefore the amber color, hue and intensity) by increasing or decreasing the total amount of iron rather than adding or removing carbon from the batch. Manipulating the iron level to control color does not affect or increase seed formation and defects and the critical working properties for forming are only minimally affected. Unlike carbon, iron directly participates in color formation. Therefore, color control is preferably made using additions or deletions of about 5 to 10 lbs of melite per 9000 lb batch as necessary to increase or decrease the intensity of amber color. Since the desired amber color may be achieved using iron oxide, a chromophore participant, as a reducing agent, a portion of the carbon may be removed. Accordingly, the anthracite (carbon source) is reduced from about 0.15 to 0.08 wt %. The reduction in carbon has a favorable effect on lowering the number of seed defects. Most preferably, redox control is made using a combination of iron and carbon with appropriate adjustment to both.

Increase Iron

Blast furnace slag contains some iron but not enough in proportion to its sulfur content to result in intense amber color with simultaneous low SO₂ emissions. Therefore, another source of iron should be added to the batch. Preferably, the additional iron is in the form of iron (III) oxide. Typical iron levels for amber glass range between 0.1 to 0.35 wt % Fe₂O₃. In the formula described here as representative of an embodiment of the present invention, iron is increased to about 0.54 wt % Fe₂O₃. The iron source is preferably at least 50% ferric iron. The preferred source of iron is Melite-40, a trade name for a product sold by the Calumite Company. As a result of the chemistry changes described herein, the sulfide-state sulfur retained in the glass decreased from about 0.04 to about 0.023 wt % sulfide. Nevertheless, stable amber color is maintained by using a higher iron content in the batch. The lower level of sulfur in conjunction with the higher level of iron result in an iron to sulfur ratio which is higher than the prior art.

The preferred formula according to the present invention results in glass with an iron (expressed as Fe₂O₃ equivalent) to S (expressed as SO₃ equivalent) weight ratio of about 7. The sulfur weight is expressed in terms of what it would weigh if all sulfur present was in the form of SO₃, regardless of the actual form of the sulfur. Similarly, iron is expressed as Fe₂O₃ equivalent). Typical iron to sulfur ratios in the prior art are about 3.5.

The net result of the glass formula changes described above is the preferred batch ingredient formula given in Table 2.

TABLE 2
Preferred Embodiment Batch Ingredients

| Ingredient | Weight Percent |
|---|---|
| Sand | 59.0 |
| Soda Ash | 20.1 |
| Limestone | 12.6 |
| Salt Cake | 0.04 |
| Slag | 5.1 |
| Aplite | 1.3 |
| Melite | 1.8 |
| Anthracite | 0.08 |

The glass produced using the preferred process and formula described above contains the ingredients shown in Table 3.

TABLE 3
Preferred Embodiment Final Glass Ingredients

| Oxide | Weight Percent |
|---|---|
| SiO₂ | 71.75 |
| Al₂O₃ | 2.0 |
| Fe₂O₃ | 0.5 |
| CaO | 10.3 |
| MgO | 0.74 |
| Na₂O | 13.9 |
| K₂O | 0.47 |
| S (expressed as | 0.07 |
| SO₃ equivalent) | |
| TiO₂ | 0.10 |
| MnO | 0.02 |

The embodiments shown and described above are exemplary. Many details are often found in the art and, therefore, many such details are neither shown nor described. It is not claimed that all of the details, parts, elements, or steps described and shown were invented herein. Even though numerous characteristics and advantages of the present invention have been described in the drawings and accompanying text, the description is illustrative only, and changes may be made in the detail, especially in matters of shape, size, amounts, and arrangement of the parts within the principles of the invention to the full extent indicated by the broad meaning of the terms of the attached claims.

The restrictive description and drawings of the specific examples above do not point out what an infringement of this invention would be, but are to provide at least one explanation of how to use and make the invention. The limits of the invention and the bounds of the patent protection are measured by and defined in the following claims.

1. A method for the production of amber glass comprising:
measuring the amber intensity of glass exiting a furnace; and
adjusting the amount of iron being added to the furnace in response to measuring the amber intensity.

2. The method of claim 1 wherein the iron is at least 50% ferric iron.

3. The method of claim 1 wherein the iron is in the form of Fe₂O₃.

4. The method of claim 1 further comprising the step of adding raw materials to the furnace, wherein the iron is part of the raw materials and wherein the raw materials contain less than 0.1 wt % iron pyrite.

5. The method of claim 1 further comprising the step of adding raw materials to the furnace, wherein the raw materials are substantially free of iron pyrite.

6. The method of claim 1 further comprising the step of adding raw materials to the furnace, wherein the raw materials contain less than 0.1 wt % carbon.

7. The method of claim 1 further comprising the step of adding raw materials to the furnace, wherein the raw materials contain less than 0.05 wt % salt cake.

8. The method of claim 1 further comprising the step of adding raw materials to the furnace, wherein the raw materials contain less than 4.0 lb Sulfur (expressed as SO₂ equivalent) per ton of glass.

9. The method of claim 1 further comprising the step of adding raw materials to the furnace, wherein the raw materials contain sufficient sulfur and iron to produce a final glass product having an iron (expressed as Fe₂O₃ equivalent) to sulfur (expressed as SO₃ equivalent) weight ratio of at least 6.

10. A method of producing amber glass with reduced sulfur emissions comprising the steps of:
providing glass ingredients in a glass furnace, the glass ingredients comprising sand, soda ash, lime, alumina, iron, salt cake, carbon, and blast furnace slag, or their oxide and redox equivalents;
removing glass from the furnace;
cooling a portion of the removed glass;
measuring an amber intensity of the glass; and
adjusting the amount of iron being added to the furnace in response to measuring the amber intensity.

11. A method for the production of glass comprising:
combining raw materials or their oxide or redox equivalents in a furnace, the raw materials comprising:
Sand 55-65%
Soda Ash 18-22%
Limestone 10-15%
Aplite 1-2%
Melite 1-2%
Salt Cake 0-0.05%
Anthracite 0-0.1%
Blast Furnace Slag 4-10%

12. The method of claim 11 wherein the raw materials contain less than 0.1 wt % iron pyrite.

13. The method of claim 11 wherein the raw materials are substantially free of iron pyrite.

14. The method of claim 11 wherein the raw materials contain less than 0.1% carbon.

15. The method of claim 10 further comprising adding cullet to the mixture in the furnace.

16. A composition of glass having an Fe₂O₃ to sulfur (expressed as SO₃ equivalent) ratio of at least 6 on a weight basis.

17. A method for reducing sulfur dioxide emissions while maintaining glass quality and consistent glass forming characteristics for amber glass comprising the steps of:
decreasing the sulfur present in raw materials to less than 4.0 lb S (expressed as SO₂ equivalent) per ton of glass;
minimizing sources of sulfur in raw materials nominally free of sulfur, such as sand and limestone;
using as sources of sulfur only those materials which have at least 65% of the sulfur present in the reduced (sulfide) form;
using carbon additions to achieve a redox within the range of −29 to −38;
using iron compounds which have at least 50% of the iron present in the oxidized (ferric) state;
adding or removing small amounts of iron containing materials to maintain uniformity in amber color intensity offsetting the effect of intended or unintended changes in furnace operation or raw material composition; and

18. The composition of amber glasses which, when melted in a conventional glass furnace, results in lowered sulfur dioxide emissions and amber glass, the glass raw materials comprising the following compounds or their oxide and redox equivalents, singly or in combination (per 2000 pound sand basis batch):

| | |
|---|---|
| Sand | 2000 lbs |
| Soda Ash | 400 to 500 lbs |
| Limestone | 350 to 500 lbs |
| Aplite | 30 to 60 lbs |
| Salt Cake | 0 to 5 lbs |
| Melite | 40 to 100 lbs |
| Anthracite | 0 to 8 lbs |
| Blast furnace slag | 120 to 250 lbs |

19. A method for the production of amber glass comprising: providing raw materials in a furnace, the raw materials comprising not more than 0.05 wt % salt cake and wherein at least 65% of sulfur in the raw materials is in the sulfide state.
